(19) United States
(12) Patent Application Publication
(10) Pub. No.: US 2012/0117246 A1
(43) Pub. Date: May 10, 2012

(54) Method And System For The Efficient And Automated Management of Virtual Networks

(75) Inventors: Guy Pujolle, Chatillon (FR); Omar Cherkaoui, Montreal (CA)

(73) Assignees: CENTRE NATIONAL DE LA RECHERCHE SCIENTIFIQUE, Paris (FR); UNIVERSITE PIERRE ET MARIE CURIE (PARIS 6), Paris (FR)

(21) Appl. No.: 13/383,461

(22) PCT Filed: Jul. 16, 2010
(86) PCT No.: PCT/FR10/51496

§ 371 Date: Jan. 11, 2012

(30) Foreign Application Priority Data
Jul. 16, 2009 (FR) 0954933

(51) Int. Cl. G06F 15/16

(52) U.S. Cl. 709/226; 709/223

(57) ABSTRACT

The invention relates to a method for the automated management of the performance of at least one virtual network (214, 216, 218) consisting of a plurality of virtual nodes installed on physical nodes (202, 204, 206, 208) selected from among a set of physical nodes forming an infrastructure network (200). Said method includes the following steps for each virtual network (214): determining so-called load data related to a load state of at least one virtual node (2022, 2044, 2062, 2086) of said virtual network (214); determining at least one overloaded virtual node (2086) of said virtual network (214) on the basis of said data and of at least one predefined criterion; and redefining said overloaded virtual node (214), said overloaded node benefiting from additional resources after said redefinition.

The present invention relates to a method for the automated and high-performance management of at least one virtual network. It also relates to a system implementing such a method.

A physical network is a network comprising several physical network devices also called physical nodes of the network. A physical network device can be a router, a switch, an access point, a “middlebox”, a “home gateway”, an IP terminal, etc.

Increasingly, each of the physical nodes of a physical network comprises the equivalent of a more or less dedicated on-board computer having a Network Operating System (NOS). Moreover, the physical network devices can, increasingly, receive several network operating systems by means of virtualization. Virtualization allows each network operating system run on a physical network device to represent an instance of a virtual network device.

Thus virtual networks are now seen in which several instances of virtual network devices are networked, each installed on a device of a network of physical devices from among a plurality of physical network devices constituting a domain.

Thus, it is nowadays possible to install several virtual devices on a single physical network device, each of these virtual devices constituting a virtual node of one or more virtual networks.

The inventors of the present invention have discovered that such a possibility of installing several virtual devices on a single physical network device is accompanied by a need for automated and high-performance management of each of the virtual networks.

At present, however, there is no method or system for the automated and high-performance management of one or more virtual networks.

A purpose of the present invention is to overcome the aforesaid drawbacks.

Another purpose of the present invention is to propose a method and a system for the automated and high-performance management of one or more virtual networks making it possible to monitor and improve the functioning of the virtual networks.

Another purpose of the present invention is to propose an easily implemented method and system for the automated and high-performance management of one or more virtual networks.

Finally, a purpose of the present invention is to propose a more flexible method and a system f or the automated and high-performance management of one or several virtual networks.

The invention proposes achieving the aforesaid purposes by a method for the automated and high-performance management of at least one virtual network composed of several virtual nodes installed on physical nodes chosen from a set of physical nodes forming an infrastructure network, said method comprising the following steps for each virtual network:
determining data, called load data, relating to a load state of at least one virtual node of said virtual network,
determining at least one overloaded virtual node of said virtual network according to said data, and to at least one predefined criterion, and
redefining said overloaded virtual node, said overloaded node benefiting from additional resources after said redefinition.

The method according to the invention makes it possible to monitor each virtual node of a virtual network by determining data relating to the load state of each virtual node.

On the basis of one or more predefined criteria, one or more overloaded virtual nodes are identified and redefined so that these overloaded nodes benefit from more resources. Thus, the virtual nodes identified as being overloaded are no longer overloaded and the virtual network has improved performance.

Identifying an overload state of a virtual node is carried out according to one or more predefined criteria. This criterion or these criteria can either be common to one or more virtual nodes of the virtual network or individualized for each virtual node of the virtual network, for example according to the function of the virtual node, the type of node, etc.

The method according to the invention makes it possible to manage the performance of the virtual networks and to improve the performance of the virtual networks in a totally automated way which is simple and easy to implement. Moreover, the method according to the invention makes it possible to carry out this management in a flexible manner and without data loss.

The method according to the invention makes it possible to identify the best possible locations for the virtual devices of a virtual network in order that the performance and the use of the resources of the physical network are optimized and to move the virtual devices when a new and better configuration is determined. Advantageously, the virtual devices are moved with no interruption of the traffic and without packet loss.

The method according to the invention allows high redundancy in the case of a malfunction and makes it possible to obtain a virtual network that is not significantly disturbed in the case of malfunction of one or more nodes.

Advantageously, the step of redefining the overloaded virtual node can comprise an allocation of additional resources at the level of the physical node on which said overloaded virtual node is installed, when said resources are available at the level of the physical node.

In this case, the method according to the invention can comprise, before the redefinition step, a step of determining resources available on the physical node on which the overloaded virtual mode is installed.

The step of redefining the overloaded virtual node can advantageously comprise a transfer of the overloaded virtual node to another physical node forming part of said infrastructure network of physical nodes and having available additional resources. In fact, when the physical node on which the overloaded virtual node is installed does not have available additional resources, then redefining the overloaded node can comprise installing the overloaded node on another physical node. This other physical node is advantageously a physical node located in the neighbourhood of the physical node on which the overloaded virtual node is installed.

In this case, and prior to the step of redefining the overloaded virtual node, the method according to the invention can comprise a step of identifying at least one physical node having available additional resources.

According to a first version of the method according to the invention, the transfer of the overloaded node to another node can comprise a transfer of the virtual device constituting said overloaded node. In this case, the virtual device acting as a virtual node is transported entirely onto another physical node.

According to a preferred version of the method according to the invention, the transfer of the overloaded node to another node can comprise a cloning of said overloaded node on said other physical node, said cloning comprising the following steps:
transmitting, to said other node, data relating to the configuration of said overloaded node according to a configuration protocol,
configuring, on said other node, a new virtual node with said data relating to the configuration of said overloaded node, and
deleting the overloaded node on the physical node on which it was previously installed.

In this preferred version, the virtual device is not transported from one physical node to another physical node, only the configuration data of the virtual node are transmitted from the physical node on which the overloaded virtual node was installed to another physical node. These configuration data are used on the new physical node in order to configure a “blank” instance of the virtual device acting as a virtual node for the overloaded node.

Thus, as the volume of configuration data is very small, the transfer of a virtual node from one physical node to another physical node is carried out in a simple, flexible and fast manner. The transfer of configuration data from one physical node to another can be carried out, for example, by using a signaling network connecting the physical nodes of the infrastructure network.

The load data relating to a state of a virtual node can comprise data relating to resources allocated to said virtual node and/or to the activity of said virtual node. Thus, by monitoring the resources allocated to a virtual node as a function of its activity it is possible to determine if the virtual node in question is in a state of overload or not. According to a particular example embodiment, it is possible to monitor the waiting time of a virtual node on a physical node in order to determine if the virtual node in question is in overload or not.

According to a particular example embodiment, in the context of a network operating system (NOS), it is important to calculate the time during which virtual routers go into latent mode. When a virtual router is in the queue, the packets which are intended for it are not processed and will very probably be lost. In the context of a UDP communication, this is a much greater constraint than in the context of a TCP communication. During a TCP communication, the drivers of the routers involved in the data transfer adapt themselves and retransmit the missing packets. On the other hand, in a UDP communication this mechanism does not exist and the packets are simply unrecognized.

For example, if 25,000 packets per second (25 packets each thousandth of a second) are processed and the virtual router is waiting for 60 thousandths of a second then 1500 packets (25×60) are lost each second. This loss must at all costs remain under the control of the network and must be able to be borne by the network. In order to control the period of time during which the virtual router remains in the queue, it is necessary to use a scheduler. This scheduler must operate by time slot and not by percentage use. It is possible to define a period during which each of the virtual routers has access to the resources of the router. In this way, it is possible to control the period of time during which each one of the virtual routers waits before receiving its time slot.

For example, if three virtual routers are installed on a physical node and it is established that a waiting time of 60 thousandths of a second is acceptable, then for each cycle (period) of 90 thousandths of a second, each virtual router must have an available time slot of 30 thousandths of a second. It is understood here that 3 virtual routers×30 thousandths of a second=90 thousandths of a second. When one virtual router is waiting, it waits for the other two virtual routers to consume their 30 thousandths of a second timeslots (2×30 thousandths of a second=60 thousandths of a second) before getting back its own time slot. The waiting time rule of 60 ms is therefore complied with. However, if one or more routers wait for more than 60 thousandths of a second, this means that at least one of these virtual routers is in an overload state because the waiting time is too long with respect to the operations it has to carry out.

Advantageously, the method according to the invention can comprise storing in at least one file per physical router, called the availability file, of at least a portion of the load data relating to the load state of each of the virtual nodes installed on a physical node. Such an availability file can be an XML file containing the load data.

Thus, identifying at least one physical node having available additional resources can comprise sharing, between at least some of the physical nodes of the infrastructure network, of the availability file associated with each of said physical nodes.

Sharing the files can be carried out in all known forms: transmitting the file to each of the physical nodes, sharing the file on each physical node such that all the physical nodes can access it there, transmitting the files to one or more servers accessible by the physical nodes and sharing the files at the level of these servers.

Advantageously, determining the load data relating to a load state of a virtual node can comprise, for each physical node:
determining at least one parameter relating to a use of the physical peripherals of said physical node by each of the virtual nodes installed on said physical node, and/or
determining at least one parameter relating to the state of each of the virtual nodes installed on said physical node, for example the use of the central processing unit or of the memory by each of the virtual nodes installed on this physical node.

According to another aspect of the invention, a computer program is proposed comprising instructions run on one or more data processing devices in order to carry out the steps of the method according to the invention. The computer program can comprise several data processing modules, identical or not and run on each of the physical nodes. The computer program can moreover comprise a central module run on a server and making it possible to generate the set of modules installed on the physical nodes.

According to another aspect of the invention, a virtual network is proposed whose performance is managed by the method according to the invention.

According to another aspect of the invention a system is proposed for the automated management of the performance of at least one virtual network composed of several virtual nodes installed on physical nodes chosen from a set of physical nodes forming an infrastructure network, said system comprising:
means for determining data, called load data, relating to a load state of at least one virtual node,
means for identifying at least one overloaded virtual node of said virtual network according to said data and least one predefined criterion,
means for redefining said overloaded virtual node such that said overloaded node benefits from additional resources.

Advantageously, the means for determining data relating to a load state of at least one virtual node can comprise a computer program, run on each physical node and which observes the activity of each virtual node installed on said physical node.

Moreover, the means for redefining an overloaded virtual node can comprise:
a computer program for allocating new resources to said virtual node on the physical node when said physical node has available additional resources, and
means for transferring said overloaded virtual node onto another physical node having available additional resources.

The system according to the invention can moreover comprise means of identifying at least one physical node having available additional resources, said means comprising at least one file, called an availability file, comprising, for each physical node, at least a portion of the load data relating to each virtual node installed on said physical node. The means of identification can moreover comprise means of sharing this file with all the physical nodes of the infrastructure network.

Thus, the state of each physical node is known to the other physical nodes, which makes it possible to identify a physical node on which additional resources are available.

According to non-limitative example embodiment, a physical node can be a physical router.

Still according to a non-limitative example embodiment, a virtual node can be a data processing device acting as a virtual router installed on a physical node.

Other advantages and features will become apparent on examining the detailed description of a non-limitative embodiment and the appended drawings in which:

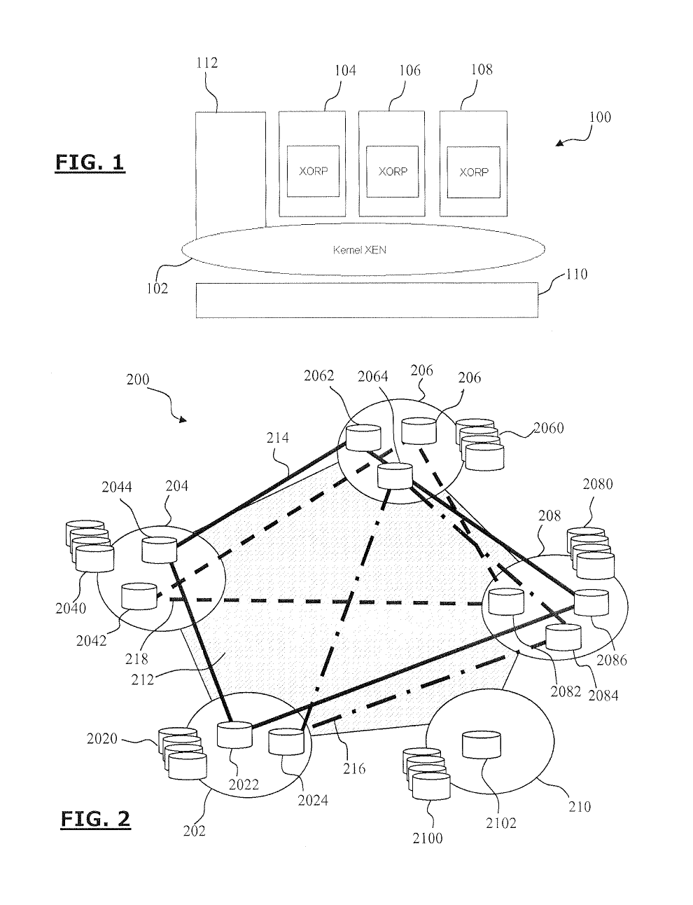

FIG. 1 is a diagrammatic representation of an architecture of a physical node on which several virtual nodes are installed; and

FIG. 2 is a diagrammatic representation of an infrastructure network comprising five physical nodes having several virtual nodes.

In the figures, the elements common to several figures retain the same references.

FIG. 1 is a diagrammatic representation of the architecture of the virtualization on a physical node of a physical network making it possible to install several virtual nodes on a physical node.

The physical node 100 shown in FIG. 1 comprises virtualization software and/or hardware 102, called a hypervisor, which has the function of sharing the physical resources between the virtual instances. An example is given by the XEN software. This hypervisor makes it possible to run several network operating systems (NOS) on the physical node 100, each of these operating systems constituting a virtual node.

In the example shown in FIG. 1, three virtual nodes 104, 106, 108 are installed on the physical node 100. Each operating system comprises XEN drivers allowing interfacing with the XEN hypervisor software 102.

The operating systems constituting the virtual nodes 104-108 can be identical or different, for example, Windows, Linux, NetBSD, FreeBSD or other operating systems.

In the present example, the virtual routers 104-108 are instances of software and/or hardware network devices, such as the XORP (Extensible Open Router Platform) software router.

The physical node moreover comprises physical peripherals 110 as well as control software and drivers 112.

FIG. 2 is a diagrammatic representation of a set 200 of physical nodes 202 to 210 interconnected by a signaling network 212. The set 200 is called an infrastructure network.

In the example shown, two virtual nodes 2022 and 2024 are installed in the physical node 202, two virtual nodes 2042 and 2044 are installed in the physical node 204, three virtual nodes 2062, 2064 and 2066 are installed in the physical node 206 and three virtual nodes 2082, 2084 and 2086 are installed in the physical node 208. No virtual node is installed on the physical node 210.

By means of virtualization, the network of physical nodes comprising the nodes 202 to 210 allows the establishment of three virtual networks: 214, 216 and 218.

Each physical node 202 to 210 comprises a stock of unconfigured “blank” virtual nodes, namely the stock 2020 for the node 202, the stock 2040 for the node 204, the stock 2060 for the node 206, the stock 2080 for the node 208 and the stock 2100 for the node 2010. Each of the virtual nodes at each of the physical nodes is obtained by a particular configuration of a blank virtual node, chosen from the virtual node stock. The configuration of the virtual node depends on the services established in the virtual network and is adapted to these services, namely, for example, banking transactions, telecommunications, etc.

The management of the performance of the virtual network 214 according to the invention will now be described.

It is considered that the physical nodes 202 to 210 are physical routers and the virtual nodes are virtual routers.

The first phase of performance management according to the invention corresponds to knowledge within each physical router of the resources available to it and their use.

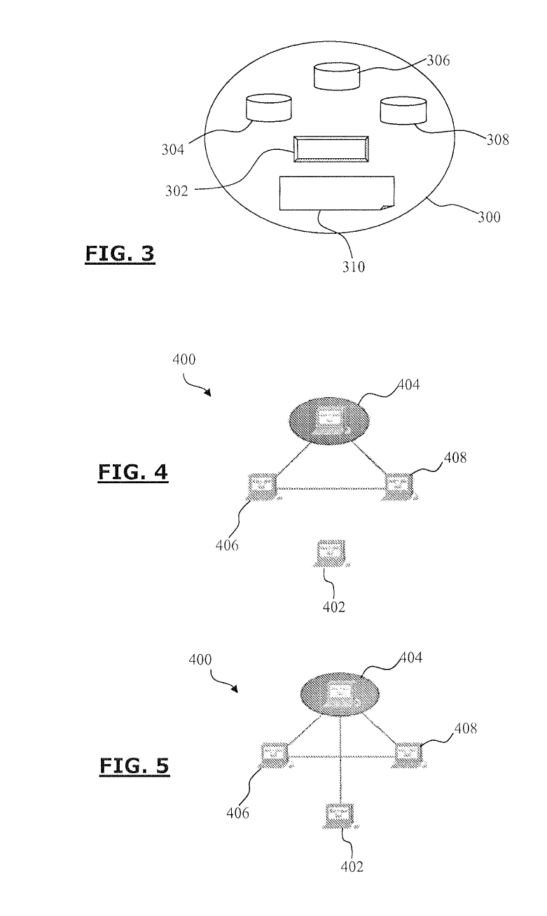

With reference to FIG. 3, a computer program 302 is run on each physical node 300. This computer program 302 monitors the activity of each of the virtual nodes 304 to 306 installed on the physical node 300. The data relating to the load state of each of the virtual nodes 304 to 306 are integrated in a data file 310, for example in the XML format.

The computer program 302, installed on each physical router, can be integrated in the hypervisor software 102 with reference to FIG. 1.

An example of determining internal resources will now be described. In the context of a network operating system (NOS), it is important to calculate the time during which the virtual routers go into latent mode. When a virtual router is in the queue, the packets which are intended for it risk being lost if they are not processed rapidly. In the context of a UDP communication, this constraint is much more important than in the context of a TCP communication. During a TCP communication, the drivers of the routers involved in the data transfer adapt themselves and retransmit the missing packets. On the other hand, in a UDP communication, this mechanism does not exist and the packets are simply unrecognized. For example, if 25,000 packets per second (25 packets each thousandth of a second) are processed and the virtual router is waiting for 60 thousandths of a second then 1500 packets (25×60) are lost each second. This loss must at all costs remain under the control of the network and must be able to be borne by the network. In order to control the period of time during which each virtual router remains in the queue, it is necessary to use a scheduler. This scheduler must operate by time slots and not by percentage use. It is possible to define a period during which each of the virtual routers has access to the resources of the router.

In this way, it is possible to control the period of time during which each of the virtual routers waits before receiving its time slot.

For example, if there are three virtual routers, namely the virtual routers 2082, 2084 and 2086 on the physical router 208 and shown in FIG. 2, and if it is established that the waiting time of 60 thousandths of a second is acceptable, then for each cycle (period) of 90 thousandths of a second, each virtual router 2082, 2084 and 2086 must have an available time slot of 30 thousandths of a second. It is understood here that 3 virtual routers×30 thousandths of a second=90 thousandths of a second. When a virtual router is waiting, for example the virtual router 2086, it waits for the other two virtual routers, i.e. the routers 2082 and 2084, to consume their 30 thousandths of a second time slot; 2×30 thousandths of a second=60 thousandths of a second before regaining its own time slot. The 60 ms waiting rule is therefore complied with. However, if the router 2086 undergoes a waiting time longer than 60 ms, then the performance of the virtual network 214 is affected and the router 2086 is overloaded.

For the internal management of physical resources, the invention depends, according to a particular embodiment, on various usage meters of the virtual routers. The parameters observed are the real use of the physical peripherals of the virtual router as well as the state of each of the virtual routers.

Once the internal resources of each physical router are known as well as the activity of each virtual router installed on the physical router in question, each physical router must discover the neighbouring physical devices, namely the neighbouring routers, and then share its resources information with the neighbouring devices.

The information previously gathered and integrated in a data file, for example an XML file, is shared with the routers of this neighbourhood. One possibility among others for carrying out this sharing consists in using a P2P protocol. For example, it is possible to choose a minimal implementation of the P2P protocol, for example Gnutella, with a data model, for example in the XML format. This solution provides great interface flexibility and great facility for optionally extending the functionalities of the method.

As proposed by the P2P model, the infrastructure network 200 is formed of physical routers which serve as “peer” routers. Among these routers, several physical routers serve as “ultrapeer” physical routers. The function of the latter is to serve as entry points on the infrastructure network 200. Each “peer” router manages a topology file which comprises the set of “peer” routers and their interconnections as well as an availability file indicating the availability of the virtual routers attached to the various “peers”. These data files can be of the XML type.

The concept used is described with reference to FIGS. 4 to 6. This concept, described independently of the infrastructure network 200 for greater clarity, is used in the infrastructure network 200 to allow sharing of the availability files between the different physical routers in the infrastructure network 200.

With reference to FIG. 4, when a new virtual router is connected, it is included in the topology file of the physical “peer” router 402 on which it was created. The latter contacts an “ultrapeer” router 404 by means of the P2P network 400.

With reference to FIG. 5, the “peer” router 402 is connected with the “ultrapeer” router 404, through the P2P network which can be seen as a signaling network. The “ultrapeer” router 404 adds the virtual router shown in the topology file of the “peer” 402 to its own topology file for the subsequent establishment of new virtual networks. Thus the list of known virtual routers is constructed automatically.

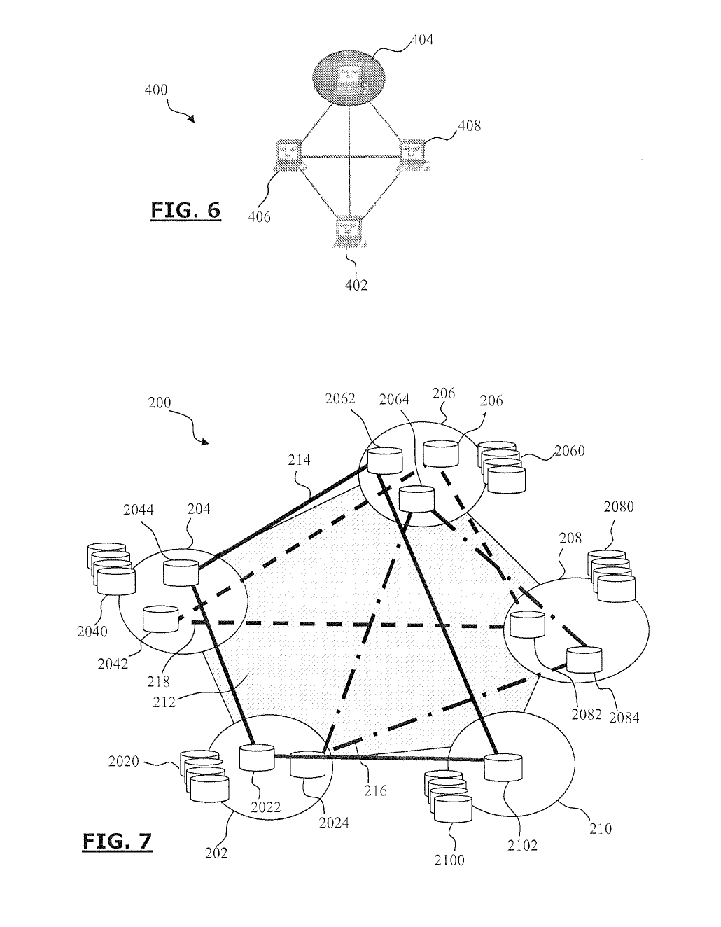

With reference to FIG. 6, the “ultrapeer” router then contacts each of the “peer” routers, namely the routers 404 and 406. The contacted “peer” routers then add the new virtual router to their own topology file. This list allows a rapid propagation of the changes in the network.

The “peer” router 402 then downloads the resources availability data file, for example an XML availability file, from each of the contacted “peer” routers 404-408 and constructs its own representation of the available resources.

When an overloaded router is discovered, the method according to the invention can comprise a phase consisting of determining the best possible location of the virtual router or routers. This determination is carried out according to a predetermined algorithm. For example, the physical router which possesses the overloaded virtual router consults its availability file and determines the least loaded physical router in its environment, which can for example be the physical routers situated one hop from itself as indicated by the topology file. If nothing is found at one hop, it searches at two hops, etc, until it finds an acceptable physical router. Then, it initiates an updating of a routing algorithm taking account of the state of the links (OSPF for example) on the infrastructure network, taking account only of physical routers on which are installed virtual routers of the virtual network in the process of modification, taking care to remove the physical router on which the moved virtual router will disappear and adding the physical router on which the moved virtual router will appear. The link states used in the routing algorithm are those of the physical links and not the link states of the virtual network. The result of the routing is however applied only to the routing tables of the virtual network which is in the process of modification.

The purpose of this algorithm is to determine which physical router is targeted to receive the overloaded virtual router on which an inactive virtual router is already working and the new routing tables of the virtual network in which a virtual router has been moved.

When the target physical router has been designated, it begins by constructing its table of interfaces and sends a “gratuitous ARP” (“gratuitous” request of the Address Resolution Protocol). This has the effect of making the new interfaces active on the segment where the new router is connected. Then, the routing process contacts its peers and the exchange of routing tables takes place. The router then reconstructs its new routing table. The convergence time of the network is equal to the time for loading the configuration and transferring the routing tables.

A configuration protocol, for example of the Netconf type, makes it possible to establish an exchange interface between the hypervisor and its virtual routers. This configuration protocol makes it possible, among other things, to read and write information on a remote host using primitives of the types:
get-config which fully returns the router configuration
edit-config which overwrites the router configuration.

These two primitives therefore make it possible to move the virtual router and to make the source virtual router inactive. The two routers involved in the transaction are then again interrogated by the information management software which, in the following seconds, publishes the state of the new resources which will be transmitted to all the hosts of the network.

In the example shown in FIG. 2, the virtual router 2086 of the virtual network 214 is identified as being overloaded because of a waiting time longer than 60 ms. Consulting the resources of the other virtual routers shows that an inactive virtual router 2102 is identified on the physical router 210 with available resources, i.e. a waiting time of less than 60 ms. The configuration data of the overloaded virtual router 2086 are transmitted to the hypervisor of the physical router 210 according to the Netconf configuration protocol using the signaling network 214. The inactive virtual router 2102 is configured with the configuration data of the overloaded router 2086. Once the configuration is carried out, the routing tables are updated and exchanged and the virtual router 2102 replaces the router 2086. The router configuration 2086 is overwritten and the router 2086 becomes an inactive router and is returned to the router stock 2080.

FIG. 7 gives a representation of the infrastructure network 200 after redefining the router 2086 as router 2102. Before redefinition the virtual network 214 was formed by the virtual routers 2022, 2044, 2062 and 2086 whereas, after redefinition, the virtual network 214 is composed of the virtual routers 2022, 2044, 2062 and 2102.

The monitoring and management of the performance of the virtual networks 216 and 218 are carried out in a similar way to that which has just been described.

Redefining the router 2086 as router 2102 is carried out without data loss in a very short period of time.

Of course, the invention is not limited to the non-limitative example which has just been described.

1. A Method for the automated management of the performance of at least one virtual network (214, 216, 218) comprising several virtual nodes installed on physical nodes (202, 204, 206, 208) chosen from a set of physical nodes forming an infrastructure network (200), said physical nodes being interconnected through a signaling network (212), said method comprising the following steps for each virtual network (214):
determining data, called load data, relating to a load state of at least one virtual node (2022, 2044, 2062, 2086) of said virtual network (214),
determining at least one overloaded virtual node (2086) of said virtual network (214) according to said data and at least one predefined criterion, and
redefining said overloaded virtual node (214), said overloaded node benefiting from additional resources after said redefinition.

2. The method according to claim 1, characterized in that the step of redefining the overloaded virtual node (2086) comprises an allocation of additional resources at the level of the physical node (208) on which said overloaded virtual node (2086) is installed, when said resources are available at the level of the physical node (208).

3. The method according to claim 2, characterized in that it comprises, before the redefining step, a step of determining resources available on the physical node (208) on which the overloaded virtual node (2086) is installed.

4. The method according to claim 1, characterized in that the step of redefining the overloaded virtual node (2086) comprises a transfer of the overloaded virtual node (2086) to another physical node (210) forming part of said infrastructure network (200) and having available additional resources.

5. The method according to claim 4, characterized in that, prior to the redefining step, it comprises a step of identifying at least one physical node (210) having available additional resources.

6. The method according to claim 4, characterized in that the transfer of the overloaded node (2086) to another node (210) comprises a transfer of the virtual device constituting said overloaded node (2086).

7. The method according to claim 4, characterized in that the transfer of the overloaded node (2086) to another physical node (210) comprises a cloning of said overloaded node (2086) on said other physical node (210), said cloning comprising the following steps:
transmitting, to said other node, data relating to the configuration of said overloaded node (2086) according to a configuration protocol,
configuring, at said other node, a new virtual node (2012) with said data relating to the configuration of said overloaded node (2086), and
deleting the overloaded node (2086) on the physical node (208) on which it was previously installed.

8. The method according to claim 1, characterized in that the load data relating to a state of a virtual node (2022, 2044, 2062, 2086) comprises data relating to resources allocated to said virtual node (2022, 2044, 2062, 2086) and/or to the activity of said virtual node (2022, 2044, 2062, 2086).

9. The method according to claim 1, further comprising storing in at least one file (310), called the availability file, at least a portion of the load data relating to the load state of each of the virtual nodes (304, 306, 308) installed on a physical node (300).

10. The method according to claim 5, wherein identifying at least one physical node (210) having available additional resources comprises sharing, between at least a portion of the physical nodes of the infrastructure network (200), an availability file associated with each of said physical nodes (202, 204, 206, 208, 210) the availability file including at least a portion of the load data relating to the load state of each of the virtual nodes installed on a physical node.

11. The method according to claim 1, characterized in that determining the load data relating to a load state of a virtual node (2082, 2084, 2086) comprises, for each physical node (208):
determining at least one parameter relating to a use of the physical peripherals of said physical node (208) by each of the virtual nodes (2082, 2084, 2086) installed on said physical node (208), and/or
determining at least one parameter relating to the state of each of the virtual nodes (2082, 2084, 2086) installed on said physical node (208).

12. A computer program comprising instructions run on one or more data processing devices in order to carry out the steps of the method according to claim 1.

13. A virtual network (214, 216, 218) whose performance is managed by the method according to claim 1.

14. A system for the automated management of the performance of at least one virtual network (214, 216, 218) comprising several virtual nodes installed on physical nodes (202, 204, 206, 208) chosen from a set of physical nodes forming an infrastructure network (200), said physical nodes being interconnected through a signaling network (212), said system comprising:
means for determining data, called load data, relating to a load state of at least one virtual node (2022, 2044, 2062, 2086),
means for identifying at least one overloaded virtual node (2086) of said virtual network (214) according to said data and at least one predefined criterion, and
means for redefining said overloaded virtual node such that said overloaded node benefits from additional resources.

15. The system according to claim 14, characterized in that the means for determining data relating to a load state of at least one virtual node comprise a computer program (302), run on each physical node (300) and which observes the activity of each virtual node (304, 306, 308) installed on said physical node (300).

16. The system according to claim 14, characterized in that the means for redefining an overloaded virtual node comprise:
a computer program (302) for allocating new resources to said virtual node on the physical node when said physical node has available additional resources, and/or
means for transferring said overloaded virtual node onto another physical node having available additional resources.

17. The system according to claim 14, further comprising means of identifying at least one physical node having available additional resources, said means comprising at least one file (310), called an availability file, comprising, for each physical node (300), at least a portion of the load data relating to each virtual node (304, 306, 308) installed on said physical node (300).

18. The system according to claim 14, characterized in that a virtual node comprises a virtual router installed on a physical node.
